(19) United States
(12) Patent Application Publication
(10) Pub. No.: US 2020/0355271 A1
(43) Pub. Date: Nov. 12, 2020

(54) SEAL STRIP FOR SEAL ASSEMBLY AND METHOD TO FORM SAME

(71) Applicant: CMG Tech LLC, Rexford, NY (US)

(72) Inventor: Clayton M. Grondahl, Rexford, NY (US)

(21) Appl. No.: 16/866,697

(22) Filed: May 5, 2020

Related U.S. Application Data
(60) Provisional application No. 62/844,429, filed on May 7, 2019.

(51) Int. Cl. F16J 15/3292; F16J 15/3288

(52) U.S. Cl. CPC F16J 15/3292; F01D 11/08; F16J 15/3288

(57) ABSTRACT

Embodiments of the disclosure provide a seal strip for a seal assembly for a turbomachine. The seal strip includes a retaining portion for fixed coupling within a recess in a stationary component of the turbomachine. A plurality of leaf members extend from the retaining portion, and a slit extends between adjacent leaf members of the plurality of leaf members. Each leaf member includes a first stepped edge and an opposing, second stepped edge, and the first stepped edge and the second stepped edge of adjacent leaf members are configured to sealingly mesh in a mounted state of the seal strip in the turbomachine.

### TECHNICAL FIELD

The present disclosure relates generally to seals for rotary machines and, more particularly, to a seal strip for a seal assembly and methods to form the same.

### BACKGROUND

In many rotary machines, such as a multi-stage centrifugal compressor or pump, a fluid is compressed by successive stages, or in turbines, a fluid is expanded in successive stages. Turbine and compressor stage(s) have stationary or non-rotating components, e.g., vanes, cooperating with rotating components, e.g., blades, for compressing and expanding the operational fluid. The operational fluids change in pressure through the machine and a variety of seals are provided to preserve the differential pressures where necessary to maximize machine efficiency and performance. An illustrative seal may be provided between a turbine or compressor rotor and a cooperating stator or stator body so the rotor may be pressurized to provide thrust balance relative to the rearwardly directed force generated by the equipment.

In the above-described settings, the seals used must address the close operating clearances required in machinery of this type. Rotary machine seal design also depends on, e.g., relative motion between components produced by the differential thermal expansion and system pressure that occurs during operation. For example, thermal expansion of various system components, at all times, must comply with clearance requirements, transient rotor dynamic displacements, etc., as the components operate at high temperatures, pressures, speeds, etc.

Conventional seal assemblies such as those described in U.S. Pat. Nos. 6,644,667 and 7,578,509 specify multiple leaf layers to block leakage flow. These layers of leaves may be bent at an angle and wrapped onto a cylindrical support with essentially no gap between leaf layers to eliminate leakage paths through the seal. This intimate nesting, i.e., fit of one leaf layer with the next, also is required to prevent vibration of seal leaves. Forming multiple layers of seal leaves while also mounting each layer onto the cylindrical support has proven to be a technical challenge associated with seal leaf assemblies. Other types of seal assemblies, which may not employ leaf seal structures, may introduce competing concerns and/or other technical challenges not appropriate for some implementations and/or systems.

### SUMMARY

Aspects of the disclosure provide a seal strip for a seal assembly for a turbomachine, the seal strip includes: a retaining portion for fixed coupling within a recess in a stationary component of the turbomachine; and a plurality of leaf members extending from the retaining portion, a slit extending between adjacent leaf members of the plurality of leaf members, wherein each leaf member includes a first stepped edge and an opposing, second stepped edge, and wherein the first stepped edge and the second stepped edge of adjacent leaf members are configured to sealingly mesh in a mounted state of the seal strip in the turbomachine.

Further embodiments of the disclosure provide a seal strip having a length sized for placement within a circumferential recess formed between a rotating component and a stationary component of a turbomachine, the seal strip including: a retaining portion for fixed coupling the stationary component; a plurality of leaf members extending from and structurally continuous with the retaining portion; and a plurality of slits extending partially inwardly from a single side of the seal strip, and substantially perpendicularly to the length of the seal strip, to separate each of the plurality of leaf members from an adjacent leaf member; wherein each leaf member includes a first stepped edge and an opposing, second stepped edge, and wherein the plurality of leaf members are moveable between: a non-mounted state in which each leaf member is free of contact with an adjacent leaf member, and a mounted state in the circumferential recess in which the first stepped edge of each leaf member sealingly meshes with the second stepped edge of a respective adjacent leaf member.

Still further embodiments of the disclosure provide a method to form a seal strip for a seal assembly, the method including: forming a first plurality of recesses within a strip of sealing material, each of the plurality of first recesses extending at most partially into a first surface of the strip of sealing material, and at most partially inward from a longitudinal edge of the strip of sealing material; and forming a second plurality of recesses within the strip of sealing material, the second plurality of recesses extending at most partially into a second surface of the strip of sealing material opposite the first surface, and at most partially inward from the longitudinal edge of the strip of sealing material, wherein each of the second plurality of recesses connects to a respective one of the first plurality of recesses to form a plurality of slits within the strip of sealing material, the plurality of slits separating remaining portions of the strip of sealing material into a plurality of leaf members, wherein each of the plurality of leaf members includes a first stepped edge and an opposing, second stepped edge.

The foregoing and other features and advantages of the disclosure will be apparent from the following more particular description of preferred embodiments of the disclosure.

### BRIEF DESCRIPTION OF THE DRAWINGS

The preferred embodiments of this disclosure will be described in detail, with reference to the following figures, wherein like designations denote like elements, and wherein:

FIG. 1 shows a perspective view of a portion of a seal strip according to an embodiment of the disclosure.

FIG. 2 shows a plan view of a portion of a seal strip according to an embodiment of the disclosure.

FIG. 3 shows a cross-sectional view of a portion of a seal strip according to an embodiment of the disclosure.

FIG. 4 shows a plan view of a seal strip with rectangular and trapezoidal leaf members according to embodiments of the disclosure.

FIG. 5 shows a plan view of a seal strip according to further embodiments of the disclosure.

FIG. 6 shows a plan view of a seal strip with rectangular leaf members according to embodiments of the disclosure.

FIG. 7 shows a cross-sectional schematic view of two adjacent leaf members in a non-mounted state according to embodiments of the disclosure.

FIG. 8 shows a cross-sectional schematic view of two adjacent leaf members in a mounted state according to embodiments of the disclosure.

FIG. 9 shows a perspective view of a portion of the seal strip in a mounted state according to embodiments of the disclosure.

FIG. 10 shows a perspective view of the seal strip in a mounted state according to embodiments of the disclosure.

FIG. 11 shows a side view along view line 11-11 of FIG. 10 of the seal strip in the mounted state according to embodiments of the disclosure.

FIG. 12 shows a plan view of deforming a seal strip in-plane according to further embodiments of the disclosure.

FIG. 13 shows an illustrative flow diagram of a method to form, and optionally, to install the seal strip according to embodiments of the disclosure.

### DETAILED DESCRIPTION

Embodiments of the disclosure provide a seal strip for a seal assembly of a turbomachine. The seal strip in some cases may be a unitary component (i.e., free of separable or mechanically distinct subcomponents) structured to fluidly sealing a recess between two elements of a turbomachine, e.g., a stationary component and a rotating component of the turbomachine. Embodiments of a seal strip according to the disclosure, in some applications, may be suitable for use without mounting additional seal strips and/or leaf members into the same location. Embodiments of the disclosure thus eliminate the need to nest and/or otherwise correspondingly mount multiple sealing components into the same location, and eliminate the need for additional alignment and/or nesting steps.

An example of a turbomachine configured to receive a seal strip according to embodiments of the disclosure may include any currently known or later developed power generation system, e.g., a gas turbine, steam turbine, water turbine, etc., having rotary components such as a compressor or turbine therein. Such rotary components may include any currently known or later developed machinery that includes a non-rotating component (e.g., a stator) and a rotating component (e.g., a rotor and/or set of rotor-mounted blades) having a longitudinal axis, e.g., a centrifugal compressor, a pump or a steam turbine, etc. For description purposes, embodiments of the present disclosure will be described in terms of a centrifugal compressor or steam turbine having a stationary body or stator, and a rotating component, or rotor. Operating fluid of the turbine flows through the machine from a high pressure area to a lower pressure area. Pressure from higher pressure area is exerted against at least part of seal assembly located between the two areas. Embodiments of a seal strip according to the disclosure are operable to seal fluids in higher pressure area from the lower pressure area.

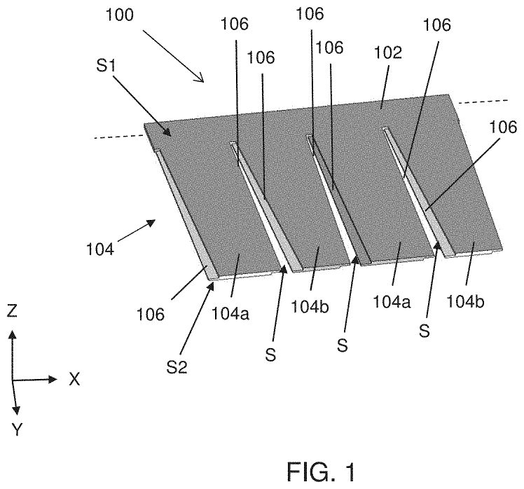

Referring to FIG. 1, a perspective view of a seal strip 100 is shown according to embodiments of the disclosure. Seal strip 100 is shown in a non-mounted (e.g., flat in plane X-Y) configuration, before being modified (e.g., partially bent) and installed in a machine. Seal strip 100 may be formed as a unitary component from a bulk (e.g., substantially rectangular) sheet of material, e.g., stainless steel, aluminum, or various other metals and/or metal alloys suitable for use in a turbomachine. For example, for high temperature power generation or aerospace applications, seal strip 100 may include a stainless steel or a nickel-based alloy. Where weight is of concern, for example, in aircraft engines, a nickel based alloy with high temperature strength, such as Inconel 718, could be used so seal strip 100 can be of minimum thickness or cross-section. In power systems, seal strip 100 could be a 400 stainless steel or Nitronic 60 alloy that is known for anti-galling characteristics running against typical turbine shaft materials. Another benefit to using 400 stainless steel or Nitronic 60 alloys is that they are compatible with various wear resistant coatings. In addition, vibration characteristics of the seal strip can be influenced by the mass of seal strip 100 which can therefore influence material selection for seal strip 100. In lower temperature applications, e.g. centrifugal compressors, seal strip 100 may be an aluminum alloy for process gas compatibility.

Seal strip 100 may include, e.g., a retaining portion 102 for fixed coupling within a recess (e.g., a circumferential recess) of a stationary component. Such recesses may appear directly between a stator and a rotating component of a turbomachine, or similar junctions between interconnected components (e.g., multiple rotating components, or between subcomponents of a single rotating component). A plurality of leaf members 104 may extend from retaining portion 102, thereby defining one or more slits S between adjacent leaf members 104. Retaining portion 102 and leaf members 104 may be formed from a single piece of raw material, e.g., by removing selected portions of a single metal strip, as described elsewhere herein. Thus, retaining portion 102 and leaf members 104 may together form portions of a single, unitary seal strip 100 according to embodiments of the disclosure. Although retaining portion 102 and leaf members 104 are described separately throughout the disclosure, it is understood that the material composition and properties of seal strip 100 may be uniform within retaining portion and leaf members 104. Despite differences in the geometrical profile and/or position of each component of seal strip 100, seal strip 100 may not have any physical interfaces, boundaries, etc., where retaining portion 102 meets leaf members 104. Each leaf member, as shown, may include a set of stepped edges 106 on opposing edges thereof. Stepped edges 106 may allow leaf members to mesh and form a seal when seal strip 100 is in a mounted state, e.g., when leaf members form a seal ring at a predetermined location. Each leaf member 104 may include, e.g., one stepped edge 106 adjacent a first slit S between adjacent leaf members 104. Each leaf member also may include a second, opposed stepped edge 106 adjacent another slit S and another adjacent leaf member 104. Several slits S optionally may have a substantial V-shape, as shown in FIG. 1.

Leaf members 104 of seal strip 100 may be formed in the shape of one or more predetermined geometries, e.g., by modifying the shape of slits S formed therebetween. Multiple geometries for leaf member(s) 104 may be included together in one seal strip 100. For example, a substantially rectangular leaf member 104a may be located adjacent a substantially trapezoidal leaf member 104b. Rectangular leaf members 104a in one example may be positioned between adjacent trapezoidal leaf members 104b in the embodiment shown in FIG. 1, but this is not necessarily true in all instances. Additionally, various other embodiments of seal strip 100 may feature only rectangular leaf members 104a, trapezoidal leaf members 104b, and/or other leaf member 104 geometries (e.g., rounded, triangular, pentagonal, composite geometries, regular polygons, irregular polygons, etc.). in a non-mounted state, each leaf member 104 may be free of contact with any adjacent leaf members 104, while being coupled to or structurally continuous with its corresponding retaining member 102.

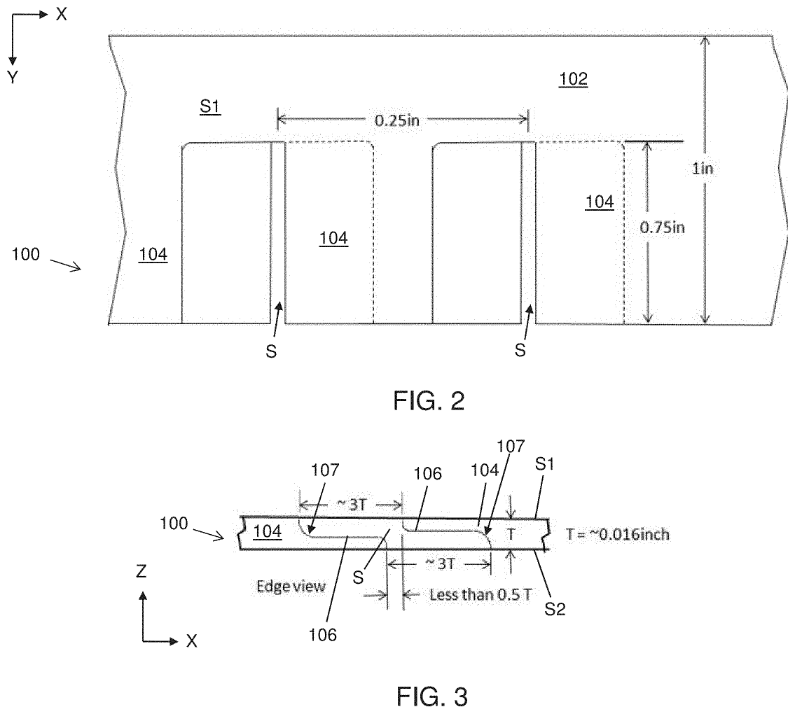

Referring to FIGS. 2 and 3 together, various geometrical properties of seal strip 100 in a non-mounted state are shown according to further embodiments. FIG. 2 depicts various features of seal strip 100 in the plane of first surface S1 using solid lines, and other portions of seal strip 100 in another plane, e.g., the plane of second surface S2 located behind the plane of the page, using dotted lines. Seal strip 100 is shown using a set of example dimensions solely to provide a non-limiting example. As shown, seal strip 100 may have a latitudinal dimension of any conceivable length, e.g., several feet or more. A longitudinal dimension of seal strip 100 by contrast may be configured for positioning within a selected recess of a stationary component, and in the example of FIG. 2 is shown to be approximately one inch (in.). The length (e.g., measured along the X-axis) of leaf member 104, whether rectangular or trapezoidal, may be between, e.g., approximately 0.15 in. and approximately 0.25 in. Retaining portion 102 may have a length (e.g., measured along the Y-axis) of, e.g., between approximately 0.15 in. and approximately 0.35 in. Leaf members 104 may extend to a length of, e.g., between approximately 0.50 in. and approximately 1.00 in. outwardly from retaining portion 102. A thickness (e.g., measured along the Z-axis) T of seal strip 100 may be, e.g., substantially less than the dimensions of seal strip 100 in the X-Y plane. According to one example, seal strip 100 may have a thickness of about 0.016 in between a first surface S1 and an opposing second surface S2 of seal strip 100. Slit S may be shaped to have a dimension of approximately 0.008 in between leaf members 104 (i.e., approximately half the thickness of seal strip 100). Stepped edges 106 may have a latitudinal length of, e.g., between approximately 0.040 in. and approximately 0.060 in. In an example implementation, stepped edges 106 may be have a length that is approximately three times the thickness of seal strip 100.

Stepped edges 106 may include a variety of geometrical profiles. For example, stepped edges 106 may feature rounded corners 107 (FIG. 3 only) as shown, e.g., to create a contoured or similar three-dimensional contact profile between adjacent leaf members 104. Where applicable, rounded corners 107 of stepped edges 106 may be formed, e.g., by chemically etching seal strip 100 material to using any currently known or later developed etching treatment to form rounded corners 107 in at least one position of leaf member(s) 104. Regardless of how stepped edges 106 are shaped, it remains possible to form a seal between adjacent leaf members 104, e.g., by bringing opposing stepped edges 106 into contact with one another.

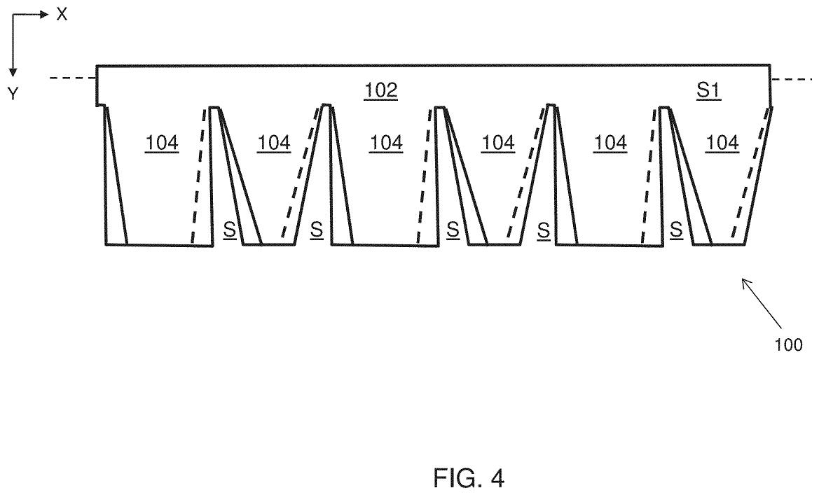

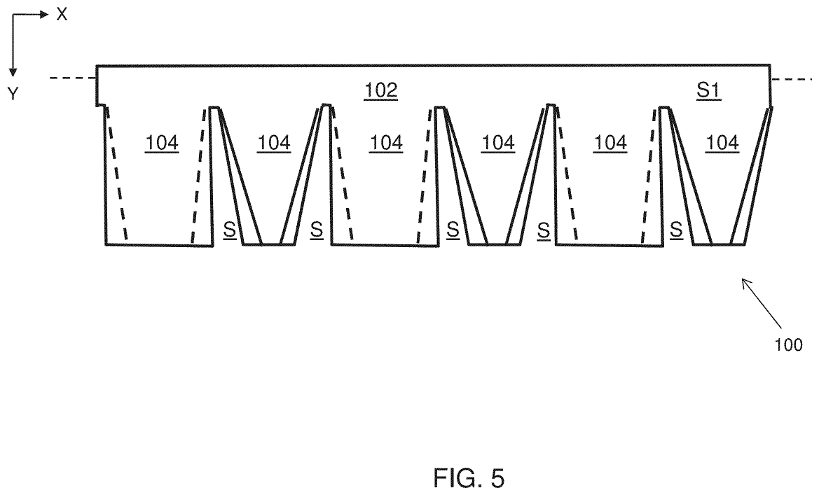

Turning now to FIGS. 4 and 5, partial views of seal strip 100 in a non-mounted state, and with a combination of rectangular and trapezoidal features, are shown according to further embodiments. As with FIG. 2, seal strip 100 is shown in a single plane using solid lines for features on first surface S1, and also shown with dotted lines for elements on second surface S2, i.e., located behind the plane of the page. Seal strip 100 depicted in FIG. 4 may have different elements on each surface S1, S2 as compared with seal strip 100 depicted in FIG. 5. Except where noted herein, each seal strip 100 shown in FIGS. 4, 5 may otherwise be substantially similar or identical. According to an example, the geometrical profile of each leaf member 104 may appear to be different based on which surface S1, S2 of seal strip 100 is visible. As discussed elsewhere herein, it is possible to form leaf members 104 by forming recesses into portions of surfaces S1, S2 of seal strip 100. By forming differently-shaped recesses in each surface S1, S2, it is possible to for leaf members 104 to have different geometrical profiles on different portions of surface S1, S2. As shown in FIG. 4, each leaf member 104 may appear substantially rectangular when viewed on first surface S1, and may appear to be substantially rectangular when viewed from second surface S2, and vice versa. In a further example shown in FIG. 5, each surface S1, S2 may include leaf members 104 with partially-rectangular and/or partially-trapezoidal portions, each of which may be in different locations on each surface S1, S2. It is thus understood that each leaf member 104 may have any desired geometrical profile and/or any conceivable combination of geometrical profiles.

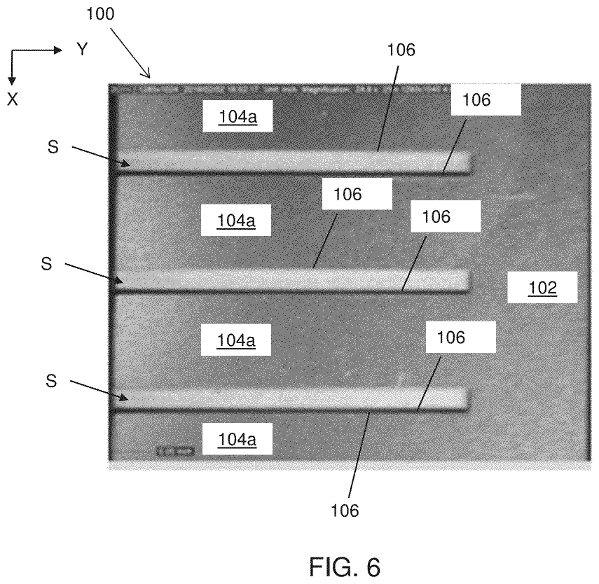

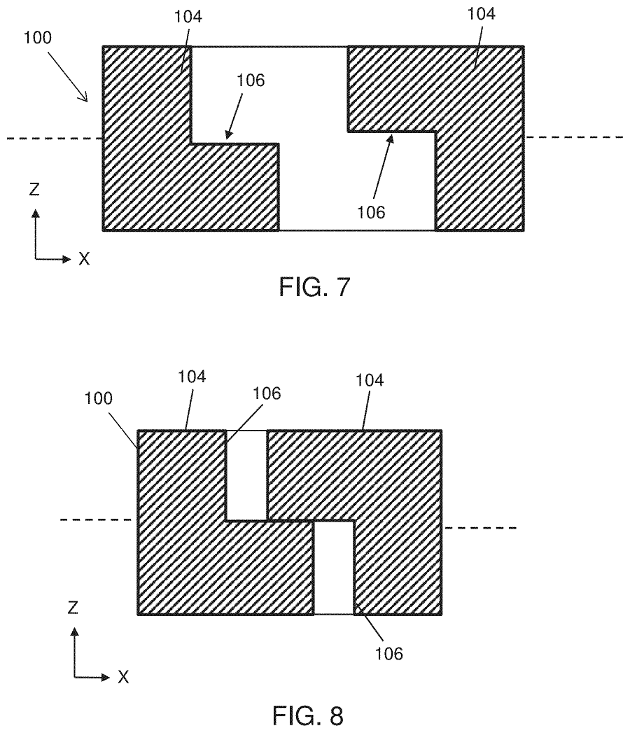

A further embodiment of seal strip 100 in a non-mounted state, and with another example set of leaf member geometries is shown in FIG. 6. In this case, seal strip 100 optionally may include only rectangular leaf members 104a without trapezoidal leaf members 104b (FIGS. 1, 4) included. In all other respects, however, seal strip 100 may include any other structural feature, dimension, etc., described herein with respect to other embodiments. It is also understood that further embodiments of seal strip 100 may include, e.g., trapezoidal leaf members 104b and/or seal leaf members 104 featuring only a single geometrical profile according to further embodiments.

Referring now to FIGS. 7 and 8, the disclosure may include stepped edges 106 oriented in multiple directions to form, e.g., a piecewise-defined seal profile between adjacent leaf members 104. FIG. 7 depicts leaf members 104 in a non-mounted (i.e., flat and unmounted) position and FIG. 8 depicts leaf members 104 in a mounted state (i.e., bent inwardly, disposed within a recess and shaped into a rounded profile). Each leaf member 104 may include multiple stepped edges 106 extending in respective directions, e.g., with each stepped edge 106 alternating between vertical and horizontal directions to define several planes of contact therebetween. FIG. 7 in particular demonstrates that each set of stepped edges 106 of adjacent leaf members 104 may be configured to face in opposing first and second directions. Seal strip 100 is shown with stepped edges 106 in contact with each other in a mounted state, thereby causing leaf members 104 to sealingly mesh and impede or substantially prevent passage of fluids therebetween. Thus, in the mounted state, at least a portion of stepped edges 106 of adjacent leaf members 104 may overlap. The overlap may be along a distal end of leaf members 104 from retaining portions 102 (FIGS. 1, 4, 5), via stepped edges 106. Embodiments with rounded corners 107 (FIG. 3) may provide further seal stability and contact between stepped edges 106, and further may reduce mechanical stresses at locations where stepped edges 106 meet each other.

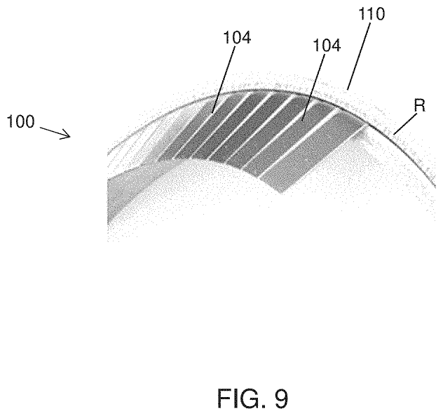

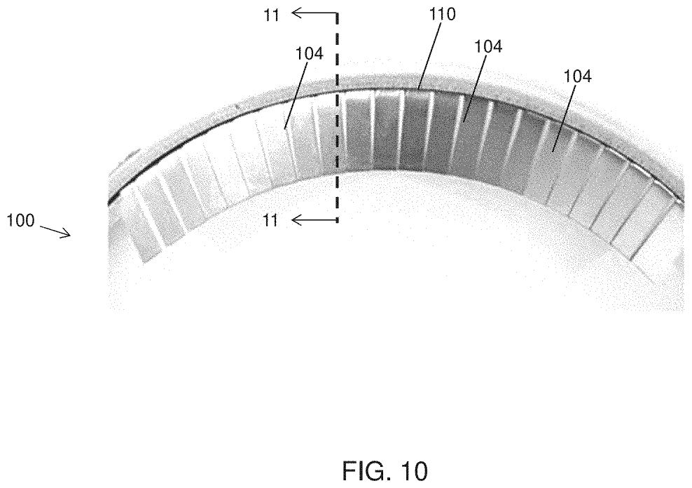

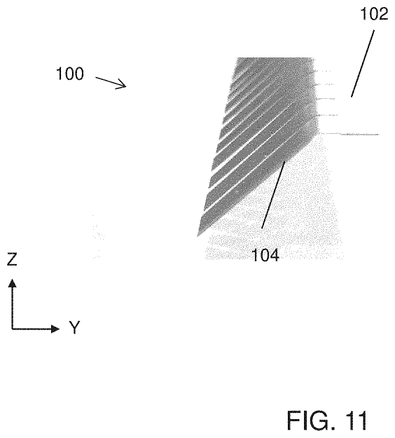

FIGS. 9-10 depict an example of a process to mount seal strip 100 within a component 110, e.g., a portion of rotating and/or stationary components of a turbomachine. Component 110 may include a recess R shaped to receive retaining portion 102 (not visible in FIGS. 9, 10) of seal strip 100 therein. A set of leaf members 104 may extend outwardly from recess R when retaining portion 102 is mounted therein. Leaf members 104 may be adjusted (e.g., by manual bending) to a radially inwardly-extending orientation, according to the view in FIG. 11 along line 11-11 of FIG. 10, so that leaf members 104 overlap with each other when mounted within recess R. As shown more specifically in FIG. 10, seal strip 100 may be sized for placement within the entirety of recess R when mounted therein. Before a machine and/or its component 110 begins operating, all leaf members 104 may overlap with at least one or two other adjacent leaf members 104 to fluidly seal adjacent chambers of a fluid flowpath from each other.

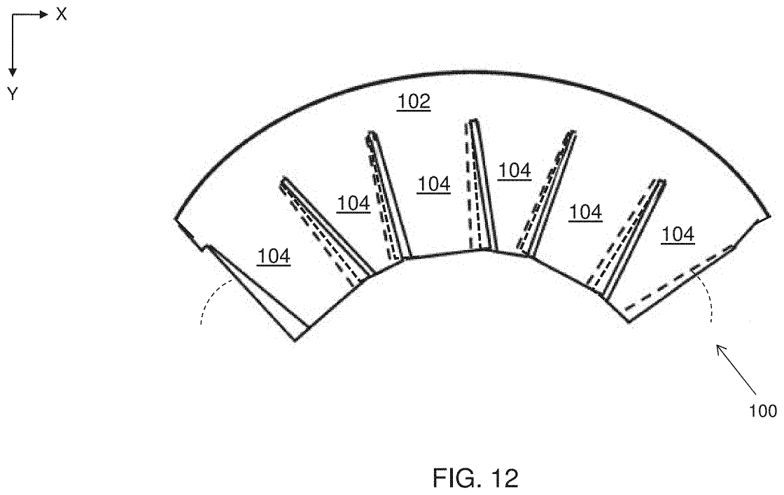

Referring to FIG. 12, seal strip 100 may be mounted and/or otherwise modified into a mounted state by alternative processes. Seal strip 100 may be mounted by way of in-plane deformation, i.e., structurally deforming seal strip 100 solely within plane X-Y without significantly bending any portion thereof within plane Z. FIG. 12 depicts in-plane deformation of seal strip 100 into a mounted state, such that stepped edges 106 thereof overlap. The in-plane deformation of seal strip 106 may be accomplished by bending or stretching seal strip 100 in plane X-Y, and about a reference axis (e.g., z-axis) to circumferentially engage the opposing ends of leaf member(s) 104. In this state, the in-plane deformation will cause adjacent leaf members 104 to overlap substantially as shown in FIG. 8. Seal strip 100 may be deformed in-plane by any currently known or later developed technique to bend a non-rounded (e.g., rectangular element) into a rounded shape, such as by roller bending methods. Other methods such as pneumatic planishing, sheet metal stretching equipment, etc., could also be used to deform seal strip 100 in-plane, such that stepped edges 106 of adjacent leaf members 104 overlap as shown:

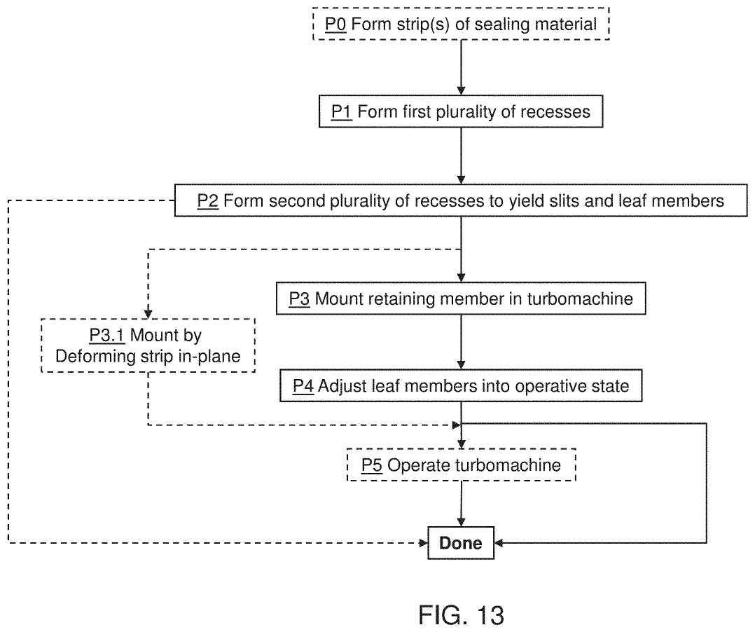

Referring to FIGS. 1 and 13 together, methods according to the disclosure are also provided. In addition to various structural features of seal strip 100, embodiments of the disclosure may provide a method to form, and optionally install, seal strip 100 with features according to any one or more of the embodiments described herein. FIG. 13 provides an illustrative flow diagram of processes P1-P5 operable to form and install seal strip 100, e.g., within one or more turbomachines, but it is understood that various processes may be added, removed, modified, etc., in any conceivable manner.

Process P0 according to the disclosure may include forming one or more strips of material, e.g., by direct manufacture or subtractive manufacture from a larger sheet of material. The strips formed in process P0 may be rectangular, or otherwise may be capable of being separated into distinct units having a desired geometry (e.g., a rectangular shape, arcuate shape, and/or any other desired geometry in plane X-Y). However, embodied, the formed strip may have the same material composition as seal strip 100, or otherwise may include material capable of being processed into one or more seal strip 100 materials.

Process P1 according to the disclosure may include forming a plurality of first recesses within one surface, e.g., first surface S1, of the formed strip. According to an example, forming the first plurality of recesses may include a photo chemical etching of the strip material. The plurality of recesses formed in process P1 may extend partially, or in some cases at most approximately halfway through, the thickness of the strip material. The strip material may not include any slits after process P1 concludes.

Process P2 according to the disclosure may include forming a plurality of second recesses within the strip material. The second plurality of recesses may be formed to extend partially into second surface S2 of the strip material, opposite surface S1. Similar to process P1, the second plurality of recesses in some cases may extend approximately halfway through the thickness of the strip material. The second plurality of recesses may be formed, e.g., by another instance of photo chemical etching of the strip material. One or more recesses in the second plurality of recesses may formed in a positional horizontally distal to a corresponding one of the first plurality of recesses. However, at least a portion of the second recess may interconnect with the first recess, thereby forming slits within the strip material as discussed elsewhere herein. Any portion(s) of the strip without slits or recesses formed therein may serve as retaining portion(s) 102. At this stage, seal strip 100 may be formed according to embodiments of the disclosure, and the method may conclude (“Done”) or optionally may proceed to further processes.

Process P3 according to the disclosure includes mounting retaining portion 102 within a turbomachine, e.g., at recess R (FIGS. 9, 10) of component 110 (FIGS. 9, 10). Retaining portion 102 may be positioned within recess R, while leaf members 104 may be positioned at least partially outside recess R. The method may then continue to process P4 of moving leaf members 104 into a mounted state. The moving of leaf members from a non-mounted state to a mounted state may include, e.g., inwardly bending leaf members 104 until stepped edges 106 overlap. Such bending may be machine-aided or automated. In the mounted state, seal strip 100 may have an inner circumference at an end of leaf members 104 that is less than an outer circumference at an opposing end at retaining portion 102. At this stage, the method may conclude (“Done”) or proceed to an additional process P5 of operating a turbomachine with seal strip 100 mounted therein.

In further implementations, the mounting of seal strip 100 may be implemented by process P3.1 of deforming seal strip 100 in-plane, e.g., as shown in FIG. 12 and discussed elsewhere herein. In such an example, the opposing lateral ends of retaining portion 102 and leaf members 104 may be bent into an arcuate shape within plane X-Y, thereby brining the opposite lateral ends of seal strip 100 into circumferential contact with each other. Once the in-plane deformation concludes, stepped edges 106 will overlap in substantially the same manner described by implementing process P3 and P4. In such an example, seal strip 100 may be mounted within a component simply by in-plane deformation of seal strip 100. Thereafter, the method may conclude (“Done”) or proceed to process P5 of operating a turbomachine with seal strip 100 mounted therein.

While embodiments of this disclosure are discussed herein in connection with a turbomachine such as a steam or gas turbine, it is understood that embodiments of this disclosure are also applicable to any situation where a seal is needed between a stationary component and a rotating component or another stationary component. In addition, embodiments of this disclosure are especially applicable to any situation with extreme variations of speeds or operating conditions, such as start-up conditions for a turbomachine, a compressor, such as a centrifugal compressor, that operates at a range of speeds (part load or over load), or aircraft applications. In aircraft applications, effective seals are especially important given the extreme conditions and very high pressures involved in transient conditions, such as take-off.

It should also be recognized that seal assemblies in accordance with the present disclosure may be combined with one or more labyrinth seals and/or one or more brush seals (not shown) to provide further sealing capacity.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc).

While various embodiments are described herein, it will be appreciated from the specification that various combinations of elements, variations or improvements therein may be made by those skilled in the art, and are within the scope of the disclosure. In addition, many modifications may be made to adapt a particular situation or material to the teachings of the disclosure without departing from essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A seal strip for a seal assembly for a turbomachine, the seal strip comprising:
a retaining portion for fixed coupling within a recess in a stationary component of the turbomachine; and
a plurality of leaf members extending from the retaining portion, a slit extending between adjacent leaf members of the plurality of leaf members,
wherein each leaf member includes a first stepped edge and an opposing, second stepped edge, and wherein the first stepped edge and the second stepped edge of adjacent leaf members are configured to sealingly mesh in a mounted state of the seal strip in the turbomachine.

2. The seal strip of claim 1, wherein the first stepped edge and the second stepped edge of adjacent leaf members are spaced from one another by a respective slit in a non-mounted state of the seal strip.

3. The seal strip of claim 1, wherein each of the plurality of leaf members includes: the first stepped edge adjacent a first slit between the respective leaf member and a first adjacent leaf member, and the opposed, second stepped edge adjacent a second slit between the respective leaf member and a second, different adjacent leaf member.

4. The seal strip of claim 1, wherein each first stepped edge faces in a first direction, and each second stepped edge faces in a second direction, the second direction opposing the first direction.

5. The seal strip of claim 1, wherein each stepped edge includes rounded corners.

6. The seal strip of claim 1, wherein, in the mounted state, the first stepped edge and the opposing, second stepped edge overlap adjacent at least a distal end of the leaf members from the retaining portion.

7. The seal strip of claim 1, wherein at least one slit between adjacent leaf member is substantially V-shaped.

8. The seal strip of claim 1, wherein at least one leaf member is substantially rectangular, and at least one adjacent leaf member is substantially trapezoidal.

9. The seal strip of claim 8, wherein the plurality of leaf members includes a substantially rectangular leaf member adjacent to a substantially trapezoidal leaf member.

10. A seal strip having a length sized for placement within a circumferential recess formed between a rotating component and a stationary component of a turbomachine, the seal strip comprising:
a retaining portion for fixed coupling the stationary component;
a plurality of leaf members extending from and structurally continuous with the retaining portion; and
a plurality of slits extending partially inwardly from a single side of the seal strip, and substantially perpendicularly to the length of the seal strip, to separate each of the plurality of leaf members from an adjacent leaf member;
wherein each leaf member includes a first stepped edge and an opposing, second stepped edge, and wherein the plurality of leaf members are moveable between:
a non-mounted state in which each leaf member is free of contact with an adjacent leaf member, and
a mounted state in the circumferential recess in which the first stepped edge of each leaf member sealingly meshes with the second stepped edge of a respective adjacent leaf member.

11. The seal strip of claim 10, wherein each leaf member includes: the first stepped edge adjacent a first slit between the respective leaf member and a first adjacent leaf member, and the opposed, second stepped edge adjacent a second slit between the respective leaf member and a second, different adjacent leaf member.

12. The seal strip of claim 10, wherein each first stepped edge faces in a first direction, and each second stepped edge faces in a second direction, the second direction opposing the first direction.

13. The seal strip of claim 10, wherein, in the mounted state in the circumferential recess, the first stepped edge and the opposing, second stepped edge overlap adjacent at least a distal end of the leaf members from the retaining portion.

14. The seal strip of claim 10, wherein at least one leaf member is substantially rectangular, and positioned adjacent at least one substantially trapezoidal leaf member.

15. The seal strip of claim 10, wherein the plurality of leaf members includes a substantially rectangular leaf member adjacent to a substantially trapezoidal leaf member.

16. A method to form a seal strip for a seal assembly, the method comprising:
forming a first plurality of recesses within a strip of sealing material, each of the plurality of first recesses extending at most partially into a first surface of the strip of sealing material, and at most partially inward from a longitudinal edge of the strip of sealing material; and
forming a second plurality of recesses within the strip of sealing material, the second plurality of recesses extending at most partially into a second surface of the strip of sealing material opposite the first surface, and at most partially inward from the longitudinal edge of the strip of sealing material,
wherein each of the second plurality of recesses connects to a respective one of the first plurality of recesses to form a plurality of slits within the strip of sealing material, the plurality of slits separating remaining portions of the strip of sealing material into a plurality of leaf members, wherein each of the plurality of leaf members includes a first stepped edge and an opposing, second stepped edge.

17. The method of claim 16, wherein forming the first or second recess includes photo-chemically etching the first or second surface of the strip of sealing material.

18. The method of claim 17, wherein the photo-chemically etching includes removing portions of the strip of sealing material to a depth of approximately one-half a thickness of the strip of sealing material between the first and second surfaces.

19. The method of claim 16, wherein forming the first recess and forming the second recess causes a non-recessed portion of the strip of sealing material to define a retaining portion of the seal strip, wherein the plurality of leaf members extend from the retaining portion.

20. The method of claim 16, wherein forming the first plurality of recesses and the second plurality of recesses includes removing selected portions of the strip of sealing material to form at least one substantially trapezoidal leaf member.
